(19) United States
(12) Patent Application Publication
(10) Pub. No.: US 2013/0272390 A1
(43) Pub. Date: Oct. 17, 2013

(54) UNIFORM GRANULARITY FOR QUANTIZATION MATRIX IN VIDEO CODING

(71) Applicant: QUALCOMM INCORPORATED, San Diego, CA (US)

(72) Inventors: Rajan Laxman JOSHI, San Diego, CA (US); Joel SOLE ROJALS, La Jolla, CA (US); Marta KARCZEWICZ, San Diego, CA (US)

(73) Assignee: QUALCOMM Incorporated, San Diego, CA (US)

(21) Appl. No.: 13/863,197

(22) Filed: Apr. 15, 2013

Related U.S. Application Data
(60) Provisional application No. 61/624,959, filed on Apr. 16, 2012.

(51) Int. Cl. H04N 7/26

(52) U.S. Cl. CPC H04N 19/00006
USPC 375/240.03

(57) ABSTRACT

The techniques of this disclosure are directed toward the use of modified quantization parameter (QP) values to calculate quantized and dequantized transform coefficients of a video block with uniform QP granularity. Conventionally, when a quantization matrix is used during quantization and dequantization of transform coefficients, the quantization matrix entries act as scale factors of a quantizer step-step corresponding to a base QP value, which results in non-uniform QP granularity. To provide uniform QP granularity across all quantization matrix entries, the techniques include calculating modified QP values for transform coefficients based on associated quantization matrix entries used as offsets to a base QP value. At a video decoder, the techniques include calculating dequantized transform coefficients from quantized transform coefficients based on the modified QP values. At a video encoder, the techniques include calculating quantized transform coefficients from transform coefficients based on the modified QP values.

This application claims to the benefit of U.S. Provisional Application No. 61/624,959, filed Apr. 16, 2012, the entire content of which is incorporated herein by reference.

### TECHNICAL FIELD

This disclosure relates to video coding and, more specifically, video compression during video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, the techniques of this disclosure are directed toward the use of modified quantization parameter (QP) values to calculate quantized and dequantized transform coefficients of a video block with uniform QP granularity. Conventionally, when a quantization matrix is used during quantization and dequantization of transform coefficients, the quantization matrix entries act as scale factors of a base quantizer step-size corresponding to a base QP value to determine a different quantizer step-size for each of the coefficients. The use of the quantization matrix entries as scale factors, however, results in non-uniform QP granularity with lower QP granularities for smaller quantization matrix entries. The smaller quantization matrix entries are typically associated with lower frequency coefficients where higher granularity would be desirable.

In order to provide uniform QP granularity across all quantization matrix entries, the techniques of the disclosure include calculating modified QP values for transform coefficients based on associated quantization matrix entries used as offsets to a base QP value. At a video decoder, or a video decoding portion of a video encoder, the techniques include calculating dequantized transform coefficients from quantized transform coefficients based on the modified QP values. At a video encoder, the techniques include calculating quantized transform coefficients from transform coefficients based on the modified QP values.

In one example, this disclosure is directed toward a method for decoding video data that includes calculating modified QP values for a plurality of quantized transform coefficients of a video block based on associated quantization matrix entries used as offsets to a base QP value, wherein the modified QP values provide uniform QP granularity across all of the quantization matrix entries, and calculating dequantized transform coefficients from the quantized transform coefficients of the video block based on the modified QP values.

In another example, this disclosure is directed toward a method for encoding video data that includes calculating modified QP values for a plurality of transform coefficients of a video block based on associated quantization matrix entries used as offsets to a base QP value, wherein the modified QP values provide uniform QP granularity across all of the quantization matrix entries, and calculating quantized transform coefficients from the transform coefficients of the video block based on the modified QP values.

In a further example, this disclosure is directed toward a video decoding device that includes a memory configured to store video data, and a processor configured to calculate modified QP values for a plurality of quantized transform coefficients of a video block based on associated quantization matrix entries used as offsets to a base QP value, wherein the modified QP values provide uniform QP granularity across all of the quantization matrix entries, and calculate dequantized transform coefficients from the quantized transform coefficients of the video block based on the modified QP values.

In another example, this disclosure is directed toward a video encoding device that includes a memory configured to store video data, and a processor configured to calculate modified QP values for a plurality of transform coefficients of a video block based on associated quantization matrix entries used as offsets to a base QP value, wherein the modified QP values provide uniform QP granularity across all of the quantization matrix entries, and calculate quantized transform coefficients from the transform coefficients of the video block based on the modified QP values.

In an additional example, this disclosure is directed toward a video decoding device that includes means for calculating modified QP values for a plurality of quantized transform coefficients of a video block based on associated quantization matrix entries used as offsets to a base QP value, wherein the modified QP values provide uniform QP granularity across all of the quantization matrix entries, and means for calculating dequantized transform coefficients from the quantized transform coefficients of the video block based on the modified QP values.

In a further example, this disclosure is directed toward a computer-readable medium comprising instructions for decoding video data, that when executed cause one or more processors to calculate modified QP values for a plurality of quantized transform coefficients of a video block based on associated quantization matrix entries used as offsets to a base QP value, wherein the modified QP values provide uniform QP granularity across all of the quantization matrix entries, and calculate dequantized transform coefficients from the quantized transform coefficients of the video block based on the modified QP values.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques described in this disclosure to calculate modified quantization parameter (QP) values for transform coefficients that provide uniform QP granularity across all entry values of a quantization matrix.

FIG. 2 is a block diagram illustrating an example video encoder that may implement the techniques described in this disclosure to calculate quantized transform coefficients based on modified QP values that provide uniform QP granularity across all entry values of a quantization matrix.

FIG. 3 is a block diagram illustrating an example video decoder that may implement the techniques described in this disclosure to calculate dequantized transform coefficients based on modified QP values that provide uniform QP granularity across all entry values of a quantization matrix.

FIG. 4 is a flowchart illustrating an example operation of calculating dequantized transform coefficients based on modified QP values, in accordance with an example of the techniques described in this disclosure.

FIG. 5 is a flowchart illustrating an example operation of calculating quantized transform coefficients based on modified QP values, in accordance with an example of the techniques described in this disclosure.

### DETAILED DESCRIPTION

Video compression techniques generally include prediction to reduce a current block to be coded to a residual block, transformation of pixel-domain values in the residual block to frequency-domain transform coefficients, and quantization of the transform coefficients to further reduce bit rate. The degree of quantization may be modified by adjusting a quantization parameter (QP) value for the transform coefficients of the video block. Following quantization, the quantized transform coefficients are entropy encoded. The encoded bitstream may be transmitted to a video decoder, or archived for later transmission or retrieval by a video decoder. At the video encoder, the quantized transform coefficients are dequantized and inverse transformed to reconstruct the video block for later use as a reference block of a reference picture. At the video decoder, the quantized transform coefficients are decoded from the received bitstream, dequantized, and inverse transformed to reconstruct the video block for display or storage.

The ITU-T H.264/MPEG-4, Part 10, Advanced Video Coding (AVC) and High Efficiency Video Coding (HEVC) standards support the use of a quantization matrix to determine a different quantizer step-size for each coefficient of a video block. In one example, a video coding standard defines a basic QP granularity as equal to 6, which means that an increase in QP value by 6 results in doubling the quantizer step-size and a decrease in QP value by 6 results in halving the quantizer step-size. In other examples, a video coding standard may define the basic QP granularity with a different value, e.g., 8 or 12.

Conventionally, the quantization matrix entries act as scale factors of a base quantizer step-size corresponding to a base QP value. In this case, when a quantization matrix entry doubles or halves, it corresponds to a doubling or halving of the quantizer step-size, or equivalently, a QP change of +6 or −6. The use of the quantization matrix entries as scale factors, however, modifies the QP granularity for each transform coefficient in a non-uniform fashion. For example, on the low end, changing the quantization matrix entry from 1 to 2 effectively doubles the quantizer step-size. On the higher end, a change in the quantization matrix entry from 128 to 255 also effectively doubles the step-size. Thus, the QP granularity is much higher for high quantizer matrix values compared to low quantizer matrix values. This is counterintuitive, because typically the low quantization matrix values are used for the lower frequency transform coefficients where higher granularity would be desirable.

The techniques of this disclosure provide uniform QP granularity across all the quantization matrix entries by calculating modified QP values for transform coefficients of a video block based on associated quantization matrix entries used as offsets to a base QP value. In this way, instead of scaling the base quantizer step-size (i.e., using multiplication) based on the quantization matrix entries, the base QP value is offset (i.e., using addition) based on the quantization matrix entries. According to the techniques, the use of the quantization matrix entries as offsets enables uniform QP granularity because a uniform amount of change in a quantization matrix entry is required to double the quantizer step-size. The techniques of this disclosure further describe calculating quantized transform coefficient and dequantized transform coefficients of the video block based on the modified QP values.

As an example, a video decoder receives a bitstream from a video encoder that includes bits representing quantized transform coefficients of a video block. The video decoder decodes the quantized transform coefficients from the bitstream, and calculates modified QP values for the quantized transform coefficients based on quantization matrix entries used as offsets to a base QP value. The video decoder than calculates dequantized transform coefficients of the video block from the quantized transform coefficients based on the modified QP values in order to reconstruct the video block for display or storage.

As another example, a video encoder calculates transform coefficients of a residual video block for a video block to be encoded, and calculates modified QP values for the transform coefficients based on quantization matrix entries used as offsets to a base QP value. The video encoder then calculates quantized transform coefficients from the transform coefficients based on the modified QP values, and encodes the quantized transform coefficients in a bitstream to be transmitted to a video decoder, or archived for later transmission or retrieval by a video decoder. The video encoder may also calculate dequantized transform coefficients from the quantized transform coefficients based on the modified QP values to reconstruct the video block for later use as a reference block of a reference picture.

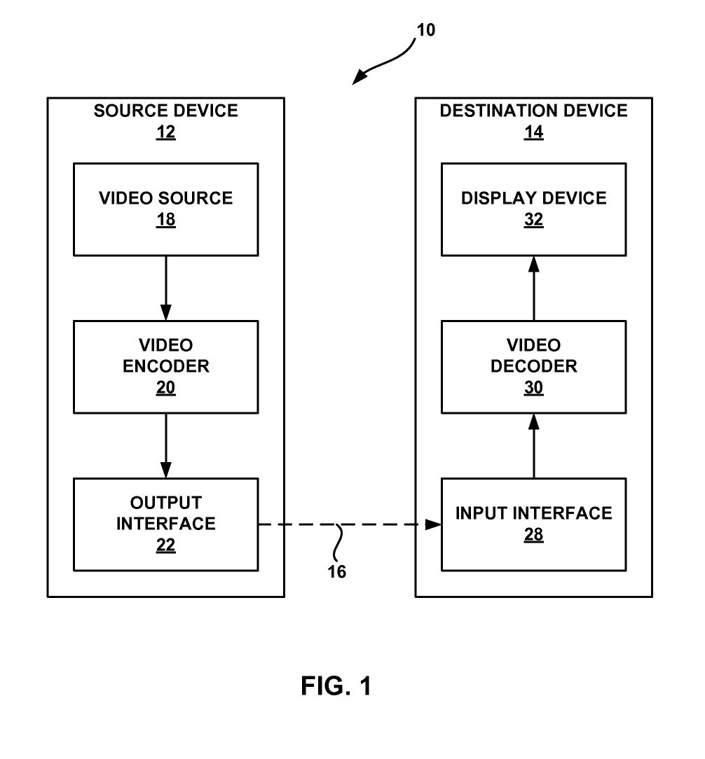

FIG. 1 is a block diagram illustrating an example video encoding and decoding system 10 that may utilize techniques described in this disclosure to calculate modified QP values for transform coefficients that provide uniform QP granularity across all entry values of a quantization matrix. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 of source device 12 to a storage device. Similarly, encoded data may be accessed from the storage device by input interface 28 of destination device 14. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may hold the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 20. The encoded video data may also (or alternatively) be stored onto a storage device for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on a storage device, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of coded treeblocks (CTBs) or largest coding units (LCUs) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding block, i.e., a coded video block. Syntax data associated with a coded bitstream may define a maximum number of times a treeblock may be split, and may also define a minimum size of the coding blocks.

A CU includes a coding blocks and prediction units (PUs) and transform units (TUs) associated with the coding block. A size of the CU corresponds to a size of the coding block and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HM allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as TUs. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list for the motion vector.

In general, a TU is used for the transform and quantization processes. A given CU having one or more PUs may also include one or more TUs. Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding block of a CU. In some specific cases, this disclosure may also use the term “video block” to refer to a treeblock, i.e., CTB or LCU, or a CU, which includes a coding block and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding block within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m. The degree of quantization may be modified by adjusting a quantization parameter (QP) value for the transform coefficients of the video block.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In addition to signaling the encoded video data in a bitstream to video decoder 30 in destination device 14, video encoder 20 may also decode the encoded video data and reconstruct the video blocks within a video frame or picture for use as reference blocks during the intra- or inter-prediction process for subsequently coded blocks. Video decoder 30 may perform a generally reciprocal process to video encoder 20 in order to reconstruct the video blocks for display or storage.

During quantization, the HM and other video coding standards support the use of a quantization matrix to determine a different quantizer step-size for each of the transform coefficients of the video block, instead of using a constant quantizer step-size for all coefficients. The HM, for example, defines a basic QP granularity as equal to 6. In other examples, the video coding standard may define the basic QP granularity with a different value, e.g., 8 or 12. Conventionally, when a quantization matrix is used during quantization and dequantization of transform coefficients, the quantization matrix entries act as scale factors of a base quantizer step-size corresponding to a base QP value to determine a different quantizer step-size for each of the coefficients. The use of the quantization matrix entries as scale factors, however, results in non-uniform QP granularity for smaller quantization matrix entries. The smaller quantization matrix entries are typically associated with lower frequency coefficients where higher granularity would be desirable.

The techniques of this disclosure are directed toward the use of modified QP values to calculate quantized and dequantized transform coefficients of a video block with uniform QP granularity. In order to provide uniform QP granularity across all quantization matrix entries, the techniques include calculating modified QP values for transform coefficients based on associated quantization matrix entries used as offsets to a base QP value. At video decoder 30, or a video decoding portion of video encoder 20, the techniques include calculating dequantized transform coefficients from quantized transform coefficients based on the modified QP values. At the video encoding portion of video encoder 20, the techniques include calculating quantized transform coefficients from transform coefficients based on the modified QP values.

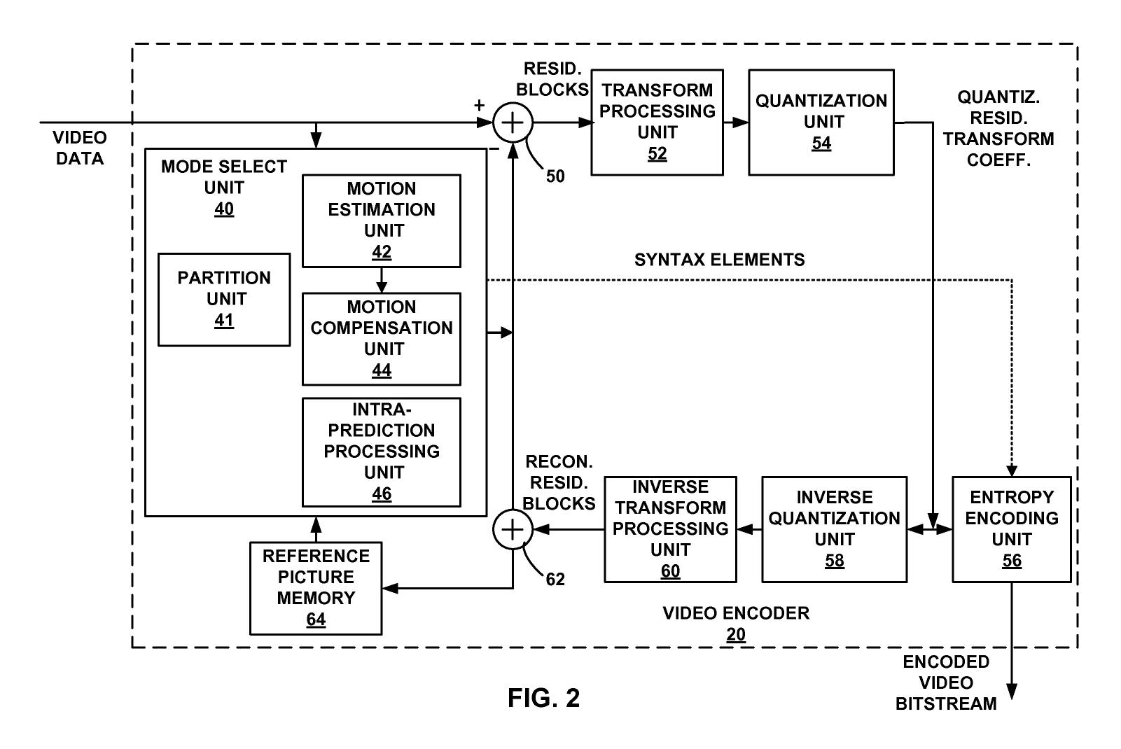

FIG. 2 is a block diagram illustrating an example video encoder 20 that may implement the techniques described in this disclosure to calculate quantized transform coefficients based on modified QP values that provide uniform QP granularity across all entry values of a quantization matrix. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes a mode select unit 40, summer 50, transform processing unit 52, quantization unit 54, entropy encoding unit 56, and reference picture memory 64. Mode select unit 40 includes partition unit 41, motion estimation unit 42, motion compensation unit 44, and intra-prediction processing unit 46. For video block reconstruction, video encoder 20 also includes inverse quantization unit 58, inverse transform processing unit 60, and summer 62. A deblocking filter (not shown in FIG. 2) may also be included to filter block boundaries to remove blockiness artifacts from reconstructed video. If desired, the deblocking filter would typically filter the output of summer 62. Additional loop filters (in loop or post loop) may also be used in addition to the deblocking filter.

As shown in FIG. 2, video encoder 20 receives video data, and partition unit 41 of mode select unit 40 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Mode select unit 40 may select one of a plurality of possible coding modes, such as one of a plurality of intra coding modes or one of a plurality of inter coding modes, for the current video block based on error results (e.g., coding rate and the level of distortion). Mode select unit 40 may provide the resulting intra- or inter-coded block to summer 50 to generate residual block data and to summer 62 to reconstruct the encoded block for use as a reference picture.

Intra-prediction processing unit 46 within mode select unit 40 may perform intra-predictive coding of the current video block relative to one or more neighboring blocks in the same frame or slice as the current block to be coded to provide spatial compression. Motion estimation unit 42 and motion compensation unit 44 within mode select unit 40 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After motion compensation unit 44 generates the predictive block for the current video block via either inter-prediction or intra-prediction, video encoder 20 uses summer 50 to form a residual video block by subtracting the predictive block from the current video block. The residual video data in the residual block may be included in one or more TUs and applied to transform processing unit 52. Transform processing unit 52 may transform the residual video data into residual transform coefficients using a transform, such as a discrete cosine transform (DCT) or a conceptually similar transform. Transform processing unit 52 may convert the residual video data from a pixel domain to a transform domain, such as a frequency domain. In some cases, transform processing unit 52 may apply a 2-dimensional (2-D) transform (in both the horizontal and vertical direction) to the residual data in the TUs. In some cases, transform processing unit 52 may instead apply a horizontal 1-D transform, a vertical 1-D transform, or no transform to the residual data in each of the TUs.

Transform processing unit 52 may send the resulting transform coefficients to quantization unit 54. Quantization unit 54 quantizes the transform coefficients to further reduce the bit rate. The quantization process may reduce the bit depth associated with some or all of the coefficients. The degree of quantization may be modified by adjusting a quantization parameter (QP) value. Video encoder 20 may calculate a QP value for the video block at one of a picture level, a slice level, a CU level, or a TU level. The determined QP value may be signaled or to a video decoder in one of a picture parameter set (PPS), a slice header, a CU header, or a TU header. In some cases, the full QP value may be signaled to a video decoder. In other examples, a QP delta value may be predicted based on a QP value of the predictive block for the video block, and the QP delta value may be signaled to the video decoder.

Following quantization, entropy encoding unit 56 entropy encodes the quantized transform coefficients. Entropy encoding unit 56 may perform a scan of the matrix including the quantized transform coefficients. Entropy encoding unit 56 may then perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Summer 62 adds the reconstructed residual block to the motion compensated prediction block produced by motion compensation unit 44 to produce a reference block for storage in reference picture memory 64. The reference block may be used by motion estimation unit 42 and motion compensation unit 44 as a reference block to inter-predict a block in a subsequent video frame or picture.

In some cases, during quantization or dequantization, quantization unit 54 or inverse quantization unit 58, respectively, uses a quantization matrix to determine a different quantizer step-size for each of the transform coefficients of the video block, instead of using a constant quantizer step-size. The HM, for example, defines a basic QP granularity as equal to 6, which means that an increase in QP value by 6 results in doubling the quantizer step-size and a decrease in QP value by 6 results in halving the quantizer step-size. In other examples, a video coding standard may define the basic QP granularity with a different value, e.g., 8 or 12.

Conventionally, the quantization matrix entries act as scale factors of a base quantizer step-size corresponding to a base QP value. In this case, when a quantization matrix entry doubles or halves, it corresponds to a doubling or halving of the quantizer step-size, or equivalently, a QP change of +6 or −6. The use of the quantization matrix entries as scale factors, however, modifies the QP granularity for each transform coefficient in a non-uniform fashion. For example, on the low end, changing the quantization matrix entry from 1 to 2 effectively doubles the quantizer step-size. On the higher end, a change in the quantization matrix entry from 128 to 255 also effectively doubles the step-size. Thus, the QP granularity is much higher for high quantizer matrix values compared to low quantizer matrix values. This is counterintuitive, because typically the low quantization matrix values are used for the lower frequency transform coefficients where higher granularity would be desirable.

The techniques of this disclosure provide uniform QP granularity across all the quantization matrix entries by calculating modified QP values for transform coefficients of a video block based on associated quantization matrix entries used as offsets to a base QP value. In this way, instead of scaling the base quantizer step-size (i.e., using multiplication) based on the quantization matrix entries, the base QP value is offset (i.e., using addition) based on the quantization matrix entries. According to the techniques, the use of the quantization matrix entries as offsets enables uniform QP granularity because a uniform amount of change in a quantization matrix entry is required to double the quantizer step-size. At video encoder 20, the techniques include quantization unit 54 calculates quantized transform coefficient of the video block based on the modified QP values and inverse quantization unit 58 calculates dequantized transform coefficients of the video block based on the modified QP values.

For example, quantization unit 54 calculates modified QP values for the transform coefficients received from transform processing unit 52 based on quantization matrix entries used as offsets to a base QP value. Quantization unit 54 then calculates quantized transform coefficients from the transform coefficients based on the modified QP values. Entropy encoding unit 56 then encodes the quantized transform coefficients in a bitstream to be transmitted to a video decoder, or archived for later transmission or retrieval by a video decoder.

In addition, inverse quantization unit 58 may calculate modified QP values for the quantized transform coefficients received from quantization unit 54 based on quantization matrix entries used as offsets to a base QP value. Inverse quantization unit 58 then calculates dequantized transform coefficients from the quantized transform coefficients based on the modified QP values to reconstruct the video block for later use as a reference block of a reference picture stored in reference picture memory 64.

In one example, the modified QP value may be calculated according to the following equation.

QP_{mod} [i][j]=g*QP+(M[i][j]−offset)

In the equation, the quantization matrix entries are represented as M[i][j]. The value of g represents an integer multiple of the basic QP granularity. For example, as stated above, the video coding standard may define the basic QP granularity as equal to 6. According to the techniques, the QP granularity for the quantization matrix entries may be modified to be equal to g*6, wherein g is an integer greater than or equal to 1.

The quantization matrix may be the same size as a TU such that the transform coefficients at given positions within the TU have associated entries in the quantization matrix at corresponding positions. For example, a transform coefficient at location [i][j] of a TU may have an associated quantization matrix entry at M[i][j]. In this case, [i] represents a column position of a value starting from an upper left corner of a block or matrix, and [j] represents a row position of the value also starting from the upper left corner. The quantization matrix entries may be 8-bit unsigned entries such that values of the entries are restricted to a range of [1, 255].

In some examples, the quantization matrix entries may be known from a default scaling list for the applicable video coding standard. In other examples, the quantization matrix entries may be determined by video encoder 20 for a given video sequence, picture, or portion of a picture. In the case where video encoder 20 determines the quantization matrix entries, entropy encoding unit 56 may encode the values of the quantization matrix entries and signal the values to a video decoder within one of a sequence parameter set (SPS) or a picture parameter set (PPS).

The value of “offset” in the above equation represents an offset to the quantization matrix entries. The criterion for selecting the offset value is that it should allow for sufficient positive as well as negative offsets of the base QP value within the range of QP. In one example, a video coding standard may set a value of “offset” equal to 64 such that M[i][j] values less than 64 imply a negative offset and M[i][j] values greater than 64 imply a positive offset. In other example, the video coding standard may set the value of “offset” to any other value, such as 32 or 128, as long as the value allows for sufficient positive and negative offsets within the range of QP.

For example, in the HM, the values M[i][j] are restricted to the range [1, 255] so the value of “offset” should be a positive integer that is not set very close to either 1 or 255. In one example, where the range of the modified QP value is [0, 51], the offset value may be set to be between 15 and 45. In another example, wherein the range of the modified QP value is [0, 103], the offset value may be set to be between 50 and 80. In a further example, where the range of the modified QP value is [0, 155], the offset value may be set to be between 115 and 145.

According to the techniques, quantization unit 54 may calculate the modified QP values for each of the transform coefficients of the video block by adding an associated quantization matrix entry value to the base QP value according to the above equation. Quantization unit 54 then calculates quantized transform coefficients by dividing each of the transform coefficients with a scaling array entry for the modified QP value. When quantization matrices are not used, quantization unit 54 may set the modified QP values for each of the transform coefficients to g*QP, and the quantized transform coefficients may be calculated using the same process based on the modified QP values.

As described above, the value of g represents an integer multiple of the basic QP granularity. In some cases, it may be desirable to modify the basic QP granularity for the applicable video coding standard in order to have more control over the QP values. When the basic QP granularity is modified, quantization unit 54 calculates the modified QP values for the transform coefficients based on the associated quantization matrix entries used as offsets to the integer multiple of the base QP value, i.e., g*QP. In this example, quantization unit 54 may calculate a modified QP value for each of the transform coefficients by adding an associated quantization matrix entry value to g*QP.

Furthermore, when the basic QP granularity is modified, quantization unit 54 calculates the quantized transform coefficients based on the modified QP values and a scaling array that includes a number of entries equal to the integer multiple of the basic QP granularity, i.e., g. As one example, when QP granularity is set equal to 6, i.e., g=1, the modified QP value for the transform coefficient at position [i][j] may be equal to QP+(M[i][j]−64). In this case, the quantized transform coefficients may be calculated based on a scaling array defined as levelScale[k]={40, 45, 51, 57, 64, 72} with k=0 . . . 5. As another example, when QP granularity is set equal to 12, i.e., g=2, the modified QP value for the transform coefficient at position [i][j] may be equal to 2*QP+(M[i][j]−64). In this case, the quantized transform coefficients may be calculated based on a scaling array defined as levelScale[k]={40, 42, 45, 48, 51, 54, 57, 60, 64, 68, 72, 76} with k=0 . . . 11.

To reduce the number of bits required to calculate the quantized transform coefficients, and the dequantized transform coefficients as a video decoder, quantization unit 54 may restrict level values of the transform coefficients to 16 bits prior to calculating the quantized transform coefficients. In some cases, quantization unit 54 may also restrict values of the quantized transform coefficients to 16 bits prior to entropy coding the quantized transform coefficients.

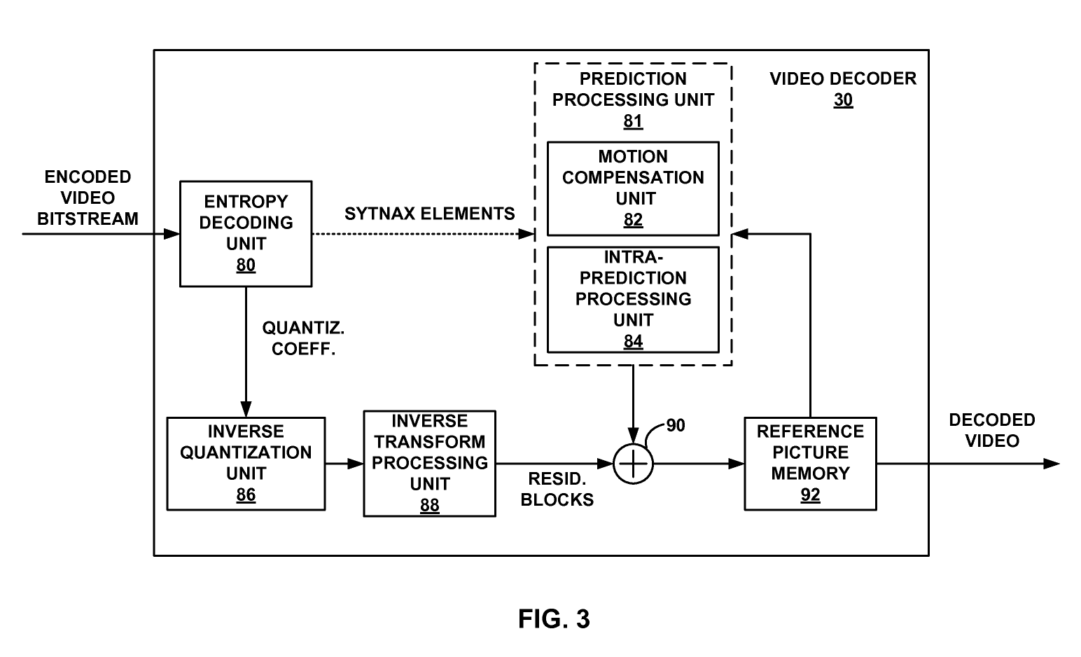

Furthermore, according to the techniques, inverse quantization unit 58 may calculate the modified QP values for each of the quantized transform coefficients of the video block by adding an associated quantization matrix entry value to the base QP value according to the above equation. Inverse quantization unit 58 then calculates dequantized transform coefficients by multiplying each of the quantized transform coefficients with a scaling array entry for the modified QP value. The techniques of calculating dequantized transform coefficients are described in more detail below with respect to video decoder 30 from FIG. 3.

FIG. 3 is a block diagram illustrating an example video decoder 30 that may implement the techniques described in this disclosure to calculate dequantized transform coefficients based on modified QP values that provide uniform QP granularity across all entry values of a quantization matrix. In the example of FIG. 3, video decoder 30 includes an entropy decoding unit 80, prediction processing unit 81, inverse quantization unit 86, inverse transform processing unit 88, summer 90, and reference picture memory 92. Prediction processing unit 81 includes motion compensation unit 82 and intra-prediction processing unit 84. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20. Entropy decoding unit 80 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements in a video parameter set (VPS), a sequence parameter set (SPS), a picture parameter set (PPS), at the video slice level, and/or at the video block level.

When the video slice is coded as an intra-coded (I) slice, intra-prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B or P) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in reference picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., dequantizes, the quantized transform coefficients provided in the bitstream and decoded by entropy decoding unit 80. The inverse quantization process may include use of a quantization parameter (QP) value calculated by video encoder 20 for each video block in the video slice to determine a degree of quantization and, likewise, a degree of inverse quantization that should be applied. The QP value for the video blocks may be indicated in the bitstream in a PPS, the slice header, the CU header, or the TU header. The indicated QP value may be the full QP value or may be a QP delta value predicted based on a QP value of the predictive block of the video block. Inverse transform processing unit 88 applies an inverse transform, e.g., an inverse DCT, an inverse integer transform, or a conceptually similar inverse transform process, to the transform coefficients in order to produce residual blocks in the pixel domain.

In some cases, inverse transform processing unit 88 may apply a 2-dimensional (2-D) inverse transform (in both the horizontal and vertical direction) to the coefficients. In other cases, inverse transform processing unit 88 may instead apply a horizontal 1-D inverse transform, a vertical 1-D inverse transform, or no transform to the residual data in each of the TUs. The type of transform applied to the residual data at video encoder 20 may be signaled to video decoder 30 to apply an appropriate type of inverse transform to the transform coefficients.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, a deblocking filter (not shown in FIG. 3) may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference picture memory 92 also stores decoded video for later presentation on a display device, such as display device 32 of FIG. 1.

In some cases, during dequantization, inverse quantization unit 86 uses a quantization matrix to determine a different quantizer step-size for each of the quantized transform coefficients of the video block, instead of using a constant quantizer step-size. In the HM, the quantization matrix entries for the video block may be inferred from a default scaling list for the applicable video coding standard, inferred from a reference scaling list for a predictive block, or signaled in the bitstream from the video encoder. When the quantization matrix entrees are signaled, entropy decoding unit 80 may decode the values of the quantization matrix entries from one of a sequence parameter set (SPS) or a picture parameter set (PPS) for the bitstream. Video decoder 30 may support different quantization matrices for different pictures in a video sequence, different supported transform sizes, different color components of the video data, and different coding modes for the video blocks.

Let M[i][j] represent entries of a quantization matrix. The quantization matrix may be the same size as a TU such that the transform coefficients at given positions within the TU have associated entries in the quantization matrix at corresponding positions. For example, a transform coefficient at location [i][j] of a TU may have an associated quantization matrix entry at M[i][j]. In this case, [i] represents a column position of a value starting from an upper left corner of a block or matrix, and [j] represents a row position of the value also starting from the upper left corner. The quantization matrix entries may be 8-bit unsigned entries such that values of the entries are restricted to a range of [1, 255].

The HM, for example, defines a basic QP granularity as equal to 6, which means that an increase in QP value by 6 results in doubling the quantizer step-size and a decrease in QP value by 6 results in halving the quantizer step-size. In other examples, a video coding standard may define the basic QP granularity with a different value, e.g., 8 or 12. Conventionally, the quantization matrix entries act as scale factors of a base quantizer step-size corresponding to a base QP value. Given the range of M[i][j], the value of 16 represents no change to the quantization for a transform coefficient at position [i][j] when the quantization matrix entries are normalized by 16. Table 1 below enumerates QP change. In the example of basic QP granularity equal to 6, when the normalized value of M[i][j]/16 doubles or halves, it corresponds to the doubling or halving of the quantizer step-size, or equivalently, a QP change of +6 or −6. Intermediate values are also allowed.

TABLE 1

| M[i][j]/16 | QP Change |
|---|---|
| 1/16 | −24 |
| ⅛ | −18 |
| ¼ | −12 |
| ½ | −6 |
| 1 | 0 |
| 2 | +6 |
| 4 | +12 |
| 8 | +18 |
| 16 | +24 |

The use of the quantization matrix entries as scale factors, however, modifies the QP granularity for each transform coefficient in a non-uniform, asymmetric fashion. For example, on the lower end, changing the quantization matrix entry from 1 to 2 effectively doubles the quantizer step-size (QP change of 6). On the higher end, a change in the quantization matrix entry from 128 to 255 also effectively doubles the quantizer step-size. Thus, the granularity of change in base QP is much higher for high quantizer matrix values compared to low quantizer matrix values. This is counterintuitive because typically quantization matrix values lower than 16 are used for lower frequencies where most of the coefficient energy is concentrated. Hence, more granularity would be desirable towards the lower end of quantization matrix values.

One solution could be to scale the quantization matrix values by a constant factor and then adjust the base QP value. The quantization matrix values are clipped at 255, however, so this solution would decrease the ability to differentiate between high and low frequencies.

The techniques of this disclosure provide uniform QP granularity across all the quantization matrix entries by calculating modified QP values for transform coefficients of a video block based on associated quantization matrix entries used as offsets to a base QP value. In this way, instead of scaling the base quantizer step-size corresponding to a base QP value (i.e., using multiplication) based on the quantization matrix entries, the base QP value is offset (i.e., using addition) based on the quantization matrix entries. According to the techniques, the use of the quantization matrix entries as offsets enables uniform QP granularity because a uniform amount of change in a quantization matrix entry is required to double the quantizer step-size. The techniques, therefore, provide an approach that offers the ability to change the base QP value uniformly. In this case, each of the quantizer matrix entries can be conceptually interpreted as a QP change with respect to the base QP value.

According to the techniques, inverse quantization unit 86 may calculate modified QP values for the quantized transform coefficients received from entropy decoding unit 80 based on quantization matrix entries used as offsets to a base QP value. Inverse quantization unit 86 then calculates dequantized transform coefficients from the quantized transform coefficients based on the modified QP values to reconstruct the video block for display, storage, or later use as a reference block of a reference picture stored in reference picture memory 92.

The techniques will be described in more detail below with respect to the following notation:
B=internal bit depth (as specified by InternalBitDepth for the applicable video coding standard)
N=transform size
M=log 2(N)
levelScale[k]={40, 45, 51, 57, 64, 72} with k=0.5
M[i][j]=8-bit unsigned quantization or scaling list matrix entries

The conventional dequantization process in which the quantization matrix entries are used as scaling factors of the base quantizer step-size corresponding to a base QP value is first described. Let c[i][j] and d[i][j] be the quantized coefficient values and dequantized coefficient values respectively. In some examples, video decoder 30 may explicitly clip the quantized coefficient values c[i][j] before the dequantization step. In other examples, video encoder 20 may restrict the quantized coefficient values c[i][j] to 16 bits prior to entropy encoding the values in the bitstream.

In the HM, with a basic QP granularity equal to 6, the dequantized or scaled transform coefficients are derived as follows.

shiftScale=(B+M−9+4−(QP/6))

If (shiftScale>0)

y[i][j]=Clip3(−32768,32768,c[i][j]),

d[i][j]=((y[i][j]*M[i][j]*levelScale[QP %6]+(1<<(shiftScale−1)))>>shiftScale,

Otherwise

LevelLimit=1<<Min(15,12+B+M−(QP/6)),

y[i][j]=Clip3(−LevelLimit,LevelLimit−1,c[i][j]),

d[i][j]=y[i][j]*M[i][j]*levelScale[QP %6])<<(−shiftScale)

The techniques of this disclosure interpret the quantizer matrix entries as offsets to the base QP value, instead of as scaling factors. In one example, the modified QP value may be calculated according to the following equation.

QP_{mod} [i][j]=g*QP+(M[i][j]−offset)

In the equation, the quantization matrix entries are represented as M[i][j]. The value of g represents an integer multiple of the basic QP granularity. For example, as stated above, the video coding standard may define the basic QP granularity as equal to 6. According to the techniques, the QP granularity for the quantization matrix entries may be modified to be equal to g*6, wherein g is an integer greater than or equal to 1.

Inverse quantization unit 86 may clip each of the modified QP values to be within a modified range equal to the integer multiple of a range for QP values at the basic QP granularity range for QP values at the basic QP granularity. In one example, when g=2 and the modified QP granularity is equal to 12, the modified QP values may be clipped to the range [0, 119].

The value of “offset” in the above equation represents an offset to the quantization matrix entries. The criterion for selecting the offset value is that it should allow for sufficient positive as well as negative offsets of the base QP value within the range of QP. In one example, a video coding standard may set a value of “offset” equal to 64 such that M[i][j] values less than 64 imply a negative offset and M[i][j] values greater than 64 imply a positive offset. In other example, the video coding standard may set the value of “offset” to any other value, such as 32 or 128, as long as the value allows for sufficient positive and negative offsets within the range of QP.

For example, in the HM, the values M[i][j] are restricted to the range [1, 255] so the value of “offset” should not be set to be very close to either 1 or 255. In one example, where the range of the modified QP value is [0, 51], the offset value may be set to be between 15 and 45. In another example, wherein the range of the modified QP value is [0, 103], the offset value may be set to be between 50 and 80. In a further example, where the range of the modified QP value is [0, 155], the offset value may be set to be between 115 and 145.

According to the techniques, inverse quantization unit 86 may calculate the modified QP values for each of the quantized transform coefficients of the video block by adding an associated quantization matrix entry value to the base QP value according to the above equation. Inverse quantization unit 86 then calculates dequantized transform coefficients by multiplying each of the quantized transform coefficients with a scaling array entry for the modified QP value. The scaling array includes a number of entries equal to the integer multiple of the basic QP granularity. For example, when g=1, the scaling entry includes 6 entries, and when g=2, the scaling entry includes 12 entries. When quantization matrices are not used, inverse quantization unit 86 may set the modified QP values for each of the transform coefficients to g*QP, and the dequantized transform coefficients may be calculated using the same process based on the modified QP values.

More specifically, the dequantized transform coefficients are calculated as described below based on the modified QP values.

d[i][j]=((c[i][j]*levelScale[QP_{mod} [i][j]%(g*6)]<<(QP_{mod} [i][j]/(g*6)))+(1<<(shift−1)))>>shift

In the above equation, shift=(B+M−9), where B is the internal bit depth, N is the transform size, and M is log 2(N). In addition, % denotes the remainder when QP_{mod} [i][j] is divided by g*6. In some examples, inverse quantization unit 86 may explicitly clip the quantized coefficient values c[i][j] before calculating the dequantized transform coefficients. In other examples, video encoder 20 may restrict the level values of the transform coefficients to 16 bits prior to calculating the quantized transform coefficients, or may restrict the quantized transform coefficient values to 16 bits prior to entropy encoding the values in the bitstream. In this example, inverse quantization unit 86 may not need to clip the quantized coefficient values before calculating the dequantized transform coefficients.

The scaling array may be defined as follows. First, the quantizer step-sizes for the modified QP values are derived.

$$Qstep [ k ] \approx {2}^{\frac{{QP}_{mo d} - 4 * g}{6 * g}} , for k = 0 , 1 , … , ( ( 6 * g ) - 1 )$$

As shown in the above quantizer step-size equation, at a QP granularity of g*6, the video coding standard defines the step-size to be 1.0 for QP_{mod} =g*4. Then, levelScale[k], k=0, 1, . . . ((6*g)−1) is chosen as follows.

$$Qstep [ k ] \approx \frac{levelScale [ k ]}{{2}^{7}}$$

In this case, multiplication by Qstep is approximated as multiplication by levelScale followed by a right-shift by 7 bits. In other examples, a different amount of right shift may be selected, resulting in a different amount of accuracy for the approximation.

In one example, the techniques of this disclosure interpret each of the quantizer matrix entries as a QP offset with half QP precision. When QP granularity is set equal to 12, i.e., g=2, the modified QP value for the transform coefficient at position [i][j] is derived as follows.

QP_{mod} [i][j]=2*QP+(M[i][j]−64).

The dequantized transform coefficients are then derived as below.

d[i][j]=((c[i][j]*levelScale[QP_{mod} [i][j]%12]<<(QP_{mod} [i][j]/12))+(1<<(shift−1)))>>shift

where levelScale[k]={40, 42, 45, 48, 51, 54, 57, 60, 64, 68, 72, 76} with k=0, 1, . . . 11.

In this example, as described above, each of the modified QP values are clipped to the range [0, 119]. By restricting the range of QP_{mod} [i][j] to [0, 119], in this example, the bit-widths needed for intermediate calculations are as follows.
c[i][j]: 16-bit signed
levelScale: 7-bit unsigned
(QP_{mod} [i][j]/12): 9-bit unsigned
   Thus, all the intermediate calculations are within 32-bit signed.

As described above, the HM sets the basic QP granularity equal to 6. Again, this means that an increase in QP value by 6 results in doubling of quantizer step-size. In this disclosure, it may be assumed that the defined granularity of 6 will be retained for the video coding standard, but the QP values may be changed at a quantization matrix level for different frequency coefficients at a granularity of g*6, where g is an integer greater than or equal to 1. If g is chosen to be 1, the QP granularity inside quantization matrices is the same as defined for the basic CODEC.

Although we have described the techniques with respect to a video coding standard where the basic QP granularity is 6, it is possible to extend these techniques for other granularities. As one example, if the basic granularity is 8 and the quantizer step-size should be 1.0 for QP=5, then levelScale can be designed as follows. First the quantizer step-sizes for QP_{mod} values are derived as follows.

$$Qstep [ k ] \approx {2}^{\frac{{QP}_{mo d} - 5 * g}{8 * g}} , for k = 0 , 1 , … , ( 8 * g - 1 )$$

For granularity of g*8, the step-size should be 1.0 for QP_{mod} =g*5. Then, levelScale[k], k=0, 1, . . . , (8*g−1) is chosen so that

$$Qstep [ k ] \approx \frac{levelScale [ k ]}{{2}^{7}} .$$

The derivation of scaled transform coefficients d[i][j] is modified as

d[i][j]=((c[i][j]*levelScale[QP_{mod} [i][j]%(g*8)]<<(QP_{mod} [i][j]/(g*8)))+(1<<(shift−1)))>>shift

The techniques may be combined with the method described in J. Chen, T. Lee, “Higher granularity of quantization parameter scaling and adaptive delta QP signaling”, JCTVC-F495, Torino, IT, July 2011, and T. Lee, J. Chen, J. H. Park, K. Chono, “CE4 Subtest 1.2.c: Higher granularity of quantization parameter scaling”, JCTVC-G773, Geneva, CH, November 2011. The Chen and Lee methods use a higher granularity at the CODEC level but may change the granularity for delta QP values with the conventional technique of using quantization matrix entries as scaling factors to a base quantizer step-size corresponding to a base QP value. For example, in the above references, QP granularity of 12 is used throughout. In that case, the granularity at the quantizer matrix level could be the same or an integer multiple of the granularity by using the techniques described above. Similarly, if the QP granularity changes at the slice level, a fixed granularity could be used at the quantization matrix level which is known to both the encoder and the decoder. In another example, the QP granularity at the quantizer matrix level could be an integer multiple of the granularity at the slice level as described above, and this integer multiple factor could be explicitly signaled to the decoder.

Potential changes to the HEVC text specification draft 6 (B. Bross, W.-J. Han, G. J. Sullivan, J.-R. Ohm, T. Wiegand (Editors), “High Efficiency Video Coding (HEVC) text specification draft 6,” JCTVC-H1003, January 2012) at Section 8.6.3: Scaling process for transform coefficients, with respect to the techniques of this disclosure are provided below.

### Section 8.6.3 Scaling Process for Transform Coefficients

Inputs of this process are:

a variable nW specifying the width of the current transform unit,

a variable nH specifying the height of the current transform unit,

a (nW)×(nH) array c of transform coefficients with elements cᵢⱼ,

a variable cIdx specifying the chroma component of the current block,

a variable qP specifying the quantization parameter.

Output of this process is scaled transform coefficients as a (nW)×(nH) array of d with elements dᵢⱼ.
The variable log 2TrSize is derived as follows:

log 2TrSize=(Log 2(NW)+Log 2(NH))>>1 (8-x)

The variable shift is derived as follows:

If cIdx is equal to 0,

shift=BitDepth_{Y}+log 2TrSize−9 (8-x)

Otherwise,

shift=BitDepth_{C}+log 2TrSize−9 (8-x)

The scaling array levelScale[•] is specified as levelScale[k]={40, 42, 45, 48, 51, 54, 57, 60, 64, 68, 72, 76} with k=0, 1, . . . 11.
The elements of array M[i][j] with i=0 . . . nW−1, j=0 . . . nH−1 are set equal to ScalingFactor[SizeID][RefMatrixID][trafoType][i*nW+j], where SizeID and RefMatrixID are specified in Table 7-2 and Equation 7-25, respectively, and trafoType is derived by

trafoType=((nW==nH)?0:((nW>nH)?1:2)) (8-x)

The elements of array qP mod [i][j] with i=0 . . . nW−1, j=0 . . . nH−1 are set as follows:

If scaling list_present_flag is equal to 0,

qP mod [i][j]=2*qP

Otherwise

qp Mod [i][j]=Clip3(0,119,(2*qP+(M[i][j]−64).

The scaled transform coefficient dᵢⱼ with i=0 . . . nW−1, j=0 . . . nH−1 is derived as follows.

dᵢⱼ=((cᵢⱼ*levelScale[qP mod [i][j]%12]<<(qP mod [i][j]/12))+(1<<(shift−1)))>>shift (8-x)

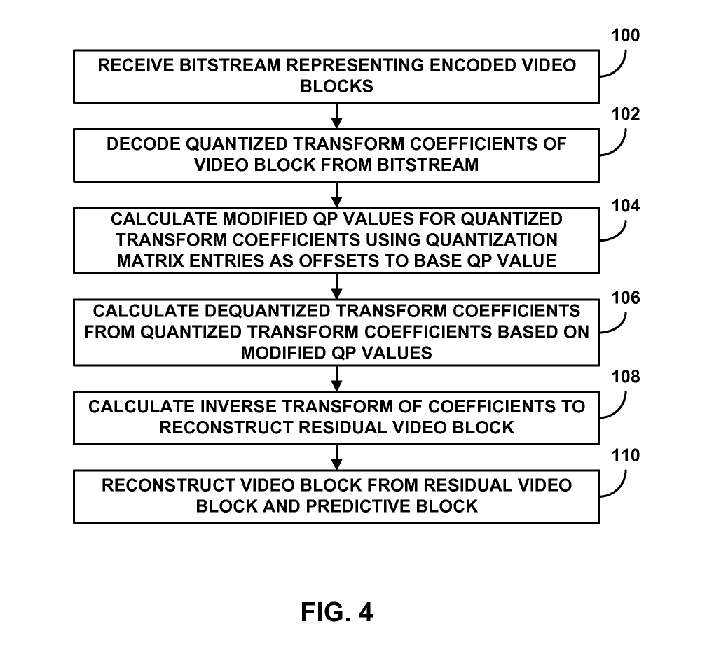

FIG. 4 is a flowchart illustrating an example operation of calculating dequantized transform coefficients based on modified QP values, in accordance with an example of the techniques described in this disclosure. The illustrated operation illustrated is described as being performed by video decoder 30 from FIG. 3. In some examples, at least a portion of the illustrated operation may be performed by video encoder 20 from FIG. 2 to reconstruct a video block for later use as a predictive block from a reference picture.

Video decoder 30 receives a bitstream representing encoded video blocks from a video encoder, such as video encoder 20, or a storage device (100). Entropy decoding unit 80 of video decoder 30 decodes quantized transform coefficients of a video block from the received bitstream (102). Entropy decoding unit 80 then sends the decoded quantized transform coefficients to inverse quantization unit 86.

Upon receiving the quantized transform coefficients, inverse quantization unit 86 calculates modified QP values for the quantized transform coefficients of the video block using associated quantization matrix entries as offsets to a base QP value (104). At video decoder 30, the quantization matrix entries for the video block may be inferred from a default scaling list for the applicable video coding standard, inferred from a reference scaling list for a predictive block, or signaled in the bitstream from the video encoder. The quantization matrix entries may be 8-bit unsigned entries such that values of the entries are restricted to a range of [1, 255].

According to the techniques, inverse quantization unit 86 uses the quantization matrix entries as offset values to a base QP value, as opposed to a scaling factor of the base quantizer step-size corresponding to the base QP value. For example, inverse quantization unit 86 calculates a modified QP value for each of the quantized transform coefficients by adding an associated quantization matrix entry value to the base QP value. By using the quantization matrix entries as offsets to the base QP value for the quantized transform coefficients, the techniques provide uniform QP granularity across all of the quantization matrix entries. Inverse quantization unit 86 may clip each of the modified QP values to be within a range for QP values at the basic QP granularity.

Inverse quantization unit 86 then calculates dequantized transform coefficients from the quantized transform coefficients based on the modified QP values (106). For example, inverse quantization unit 86 calculates a dequantized transform coefficient by multiplying a quantized transform coefficient with a scaling array entry for the modified QP value. In some cases, inverse quantization unit 86 may first clip the decoded quantized transform coefficients to 16-bit signed prior to calculating the dequantized transform coefficients. In other cases, when level values of transform coefficients are restricted to 16 bits during encoding at video encoder 20, inverse quantization unit 86 may calculate the dequantized transform coefficients without clipping the decoded quantized transform coefficients.

In some cases, it may be desirable to modify the basic QP granularity for the applicable video coding standard in order to have more control over QP values. The techniques enable the basic QP granularity to be modified by an integer multiple. For example, in the HM, the basic QP granularity is equal to 6, but the techniques allow the basic QP granularity to be modified to be equal to g*6, where g is the integer multiple that is greater than or equal to 1. In this case, inverse quantization unit 86 may clip each of the modified QP values to be within a modified range equal to the integer multiple of a range for QP values at the basic QP granularity. In one example, when g=2 and the modified QP granularity is equal to 12, the modified QP values may be clipped to the range [0, 119].

Moreover, when the basic QP granularity is modified, inverse quantization unit 86 calculates the modified QP values for the quantized transform coefficients based on the associated quantization matrix entries used as offsets to the integer multiple of the base QP value. In this example, inverse quantization unit 86 may calculate a modified QP value for each of the quantized transform coefficients by adding an associated quantization matrix entry value to the g*QP, where g is the integer multiple and QP is the base QP value.

Furthermore, when the basic QP granularity is modified, inverse quantization unit 86 calculates the dequantized transform coefficients based on the modified QP values and a scaling array that includes a number of entries equal to the integer multiple of the basic QP granularity. In HEVC, for the basic QP granularity equal to 6, the scaling array includes 6 entries with levelScale[k]={40, 45, 51, 57, 64, 72} with k=0.5. In one example, for a modified QP granularity equal to 12, the scaling array includes 12 entries with levelScale[k]={40, 42, 45, 48, 51, 54, 57, 60, 64, 68, 72, 76} with k=0, 1, . . . , 11.

After inverse quantization unit 86 calculates the dequantized transform coefficients based on the modified QP value, inverse transform processing unit 88 calculates inverse transforms of the coefficients in order to reconstruct a residual video block (108). Video decoder 30 then reconstructs the original video block from the residual video block and a predictive block (110).

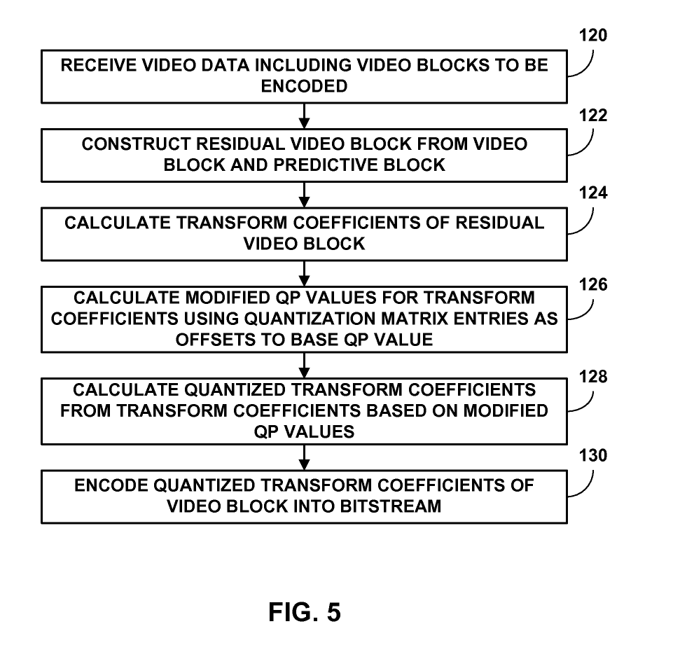

FIG. 5 is a flowchart illustrating an example operation of calculating quantized transform coefficients based on modified QP values, in accordance with an example of the techniques described in this disclosure. The illustrated operation illustrated is described as being performed by video encoder 20 from FIG. 2.

Video encoder 20 receives video data including video blocks to be encoded (120). Video encoder 20 constructs a residual video block from a video block to be encoded and a predictive block selected during motion estimation (122). Transform processing unit 52 calculates transform coefficients of the residual video block (124).

According to the techniques of this disclosure, quantization unit 54 calculates modified QP values for the transform coefficients of the video block using associated quantization matrix entries as offsets to a base QP value (126). At video encoder 20, the quantization matrix entries for the video block may be inferred from a default scaling list for the applicable video coding standard, inferred from a reference scaling list for a predictive block, or determined by video encoder 20. The quantization matrix entries may be 8-bit unsigned entries such that values of the entries are restricted to a range of [1, 255].

According to the techniques, quantization unit 54 uses the quantization matrix entries as offset values to a base QP value, as opposed to a scaling factor of the base quantizer step-size corresponding to the base QP value. For example, quantization unit 54 calculates a modified QP value for each of the transform coefficients by adding an associated quantization matrix entry value to the base QP value. By using the quantization matrix entries as offsets to the base QP value for the transform coefficients, the techniques provide uniform QP granularity across all of the quantization matrix entries. Quantization unit 54 may clip each of the modified QP values to be within a range for QP values at the basic QP granularity.

Quantization unit 54 then calculates quantized transform coefficients from the transform coefficients based on the modified QP values (128). For example, quantization unit 54 calculates a quantized transform coefficient as follows. Typically, when a quantization matrix is used, rate-distortion optimized quantization (RDOQ) is not used. In one embodiment, an absolute value of each transform coefficient is multiplied by an entry from an array “g_quantScales,” which is the counterpart of the scaling array used on the dequantization side.

In the HM, for the basic QP granularity equal to 6, the array quantScales includes 6 entries with g_quantScales[k]={26214, 23302, 20560, 18396, 16384, 14564} with k=0.5. The particular entry within the quantScales array is decided by (modQP % 6), where modQP denotes that modified QP value for a particular transform coefficient and % denotes the remainder when modQP is divided by 6. An offset, which depends on whether the block is intra or inter-coded, is added and the result is bit-shifted to the right by a certain number of bits depending at least on the block size, input bit-depth and (modQP/6), where/denotes integer division. The above described operation can be summarized as follows.

Quantized coefficient index=sign(transform coefficient)*((abs(transform coefficient)*quantScales[modQP %6]+offset)>>(right shift bits))

In some cases, quantization unit 54 may restrict level values of the transform coefficients to 16 bits prior to calculating the quantized transform coefficients. In addition, in some cases, quantization unit 54 may restrict values of the quantized transform coefficients to 16 bits prior to entropy encoding the values.

In some cases, it may be desirable to modify the basic QP granularity for the applicable video coding standard in order to have more control over QP values. The techniques enable the basic QP granularity to be modified by an integer multiple. For example, in the HM, the basic QP granularity is equal to 6, but the techniques allow the basic QP granularity to be modified to be equal to g*6, where g is the integer multiple that is greater than or equal to 1. In this case, quantization unit 54 may clip each of the modified QP values to be within a modified range equal to the integer multiple of a range for QP values at the basic QP granularity. In one example, when g=2 and the modified QP granularity is equal to 12, the modified QP values may be clipped to the range [0, 119].

Moreover, when the basic QP granularity is modified, quantization unit 54 calculates the modified QP values for the transform coefficients based on the associated quantization matrix entries used as offsets to the integer multiple of the base QP value. In this example, quantization unit 54 may calculate a modified QP value for each of the transform coefficients by adding an associated quantization matrix entry value to the g*QP, where g is the integer multiple and QP is the base QP value.

Furthermore, when the basic QP granularity is modified, quantization unit 54 calculates the quantized transform coefficients based on the modified QP values and a g_quantScales array that includes a number of entries equal to the integer multiple of the basic QP granularity. In the HM, for the basic QP granularity equal to 6, the g_quantScales array includes 6 entries with g_quantScales[k]={26214, 23302, 20560, 18396, 16384, 14564} with k=0.5. In one example, for a modified QP granularity equal to 12, the g_quantScales array includes 12 entries with g_quantScales [k]={26214, 24966, 23302, 21845, 20560, 19418, 18396, 17476, 16384, 15420, 14564, 13797} with k=0, 1, . . . , 11.

After quantization unit 54 calculates the quantized transform coefficients based on the modified QP value, entropy encoding unit 56 entropy encodes the quantized transform coefficients of video block into a bitstream (130). Video encoder 20 may then transmit the bitstream to video decoder 30 or to a storage device for later retrieval by video decoder 30.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for decoding video data, the method comprising:
calculating modified quantization parameter (QP) values for a plurality of quantized transform coefficients of a video block based on associated quantization matrix entries used as offsets to a base QP value, wherein the modified QP values provide uniform QP granularity across all of the quantization matrix entries; and
calculating dequantized transform coefficients from the quantized transform coefficients of the video block based on the modified QP values.

2. The method of claim 1, wherein calculating modified QP values comprises calculating a modified QP value for a given quantized transform coefficient by adding an associated quantization matrix entry value to the base QP value.

3. The method of claim 1, wherein calculating dequantized transform coefficients comprises calculating a dequantized transform coefficient by multiplying a given quantized transform coefficient with a scaling array entry for the modified QP value.

4. The method of claim 1, wherein calculating modified QP values comprises calculating a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry value associated with the given quantized transform coefficient, and offset indicates an offset of the quantization matrix entry value.

5. The method of claim 1, further comprising setting a modified QP granularity for the quantized transform coefficients equal to an integer multiple of a basic QP granularity.

6. The method of claim 5, further comprising clipping each of the modified QP values to be within a modified range equal to the integer multiple of a range for QP values at the basic QP granularity.

7. The method of claim 5, wherein calculating dequantized transform coefficients comprises calculating the dequantized transform coefficients based on the modified QP values and a scaling array that includes a number of entries equal to the integer multiple of the basic QP granularity.

8. The method of claim 5, wherein calculating modified QP values comprises calculating the modified QP values for the quantized transform coefficients based on the associated quantization matrix entries used as offsets to the integer multiple of the base QP value.

9. The method of claim 1, further comprising clipping the quantized transform coefficients to 16-bit signed prior to calculating the dequantized transform coefficients.

10. The method of claim 1, further comprising, when level values of transform coefficients are restricted to 16 bits during encoding, calculating the dequantized transform coefficients without clipping the quantized transform coefficients.

11. A method for encoding video data, the method comprising:
calculating modified quantization parameter (QP) values for a plurality of transform coefficients of a video block based on associated quantization matrix entries used as offsets to a base QP value, wherein the modified QP values provide uniform QP granularity across all of the quantization matrix entries; and
calculating quantized transform coefficients from the transform coefficients of the video block based on the modified QP values.

12. The method of claim 11, wherein calculating modified QP value comprises calculating a modified QP value for a given transform coefficient by adding an associated quantization matrix entry value to the base QP value.

13. The method of claim 11, wherein calculating quantized transform coefficients comprises calculating a quantized transform coefficient by dividing a given transform coefficient with a scaling array entry for the modified QP value.

14. The method of claim 11, wherein calculating modified QP values comprises calculating a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry associated with the given quantized transform coefficient, and offset indicates an offset of the quantization matrix entry.

15. The method of claim 11, further comprising setting a modified QP granularity for the transform coefficients equal to an integer multiple of a basic QP granularity.

16. The method of claim 15, further comprising clipping each of the modified QP values to be within a modified range equal to the integer multiple of a range for QP values at the basic QP granularity.

17. The method of claim 15, wherein calculating quantized transform coefficients comprises calculating the quantized transform coefficients based on the modified QP values and a scaling array that includes a number of entries equal to the integer multiple of the basic QP granularity.

18. The method of claim 15, wherein calculating modified QP values comprises calculating the modified QP values for the transform coefficients based on the associated quantization matrix entries used as offsets to the integer multiple of the base QP value.

19. The method of claim 11, further comprising restricting level values of the transform coefficients to 16 bits prior to calculating the quantized transform coefficients.

20. A video coding device for decoding video data, the device comprising:
a memory configured to store video data; and
a processor configured to calculate modified quantization parameter (QP) values for a plurality of quantized transform coefficients of a video block based on associated quantization matrix entries used as offsets to a base QP value, wherein the modified QP values provide uniform QP granularity across all of the quantization matrix entries, and calculate dequantized transform coefficients from the quantized transform coefficients of the video block based on the modified QP values.

21. The video coding device of claim 20, wherein the processor is configured to calculate a modified QP value for a given quantized transform coefficient by adding an associated quantization matrix entry value to the base QP value.

22. The video coding device of claim 20, wherein the processor is configured to calculate a dequantized transform coefficient by multiplying a given quantized transform coefficient with a scaling array entry for the modified QP value.

23. The video coding device of claim 20, wherein the processor is configured to calculate a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry value associated with the given quantized transform coefficient, and offset indicates an offset of the quantization matrix entry value.

24. The video coding device of claim 20, wherein the processor is configured to set a modified QP granularity for the quantized transform coefficients equal to an integer multiple of a basic QP granularity.

25. The video coding device of claim 24, wherein the processor is configured to clip each of the modified QP values to be within a modified range equal to the integer multiple of a range for QP values at the basic QP granularity.

26. The video coding device of claim 24, wherein the processor is configured to calculate the dequantized transform coefficients based on the modified QP values and a scaling array that includes a number of entries equal to the integer multiple of the basic QP granularity.

27. The video coding device of claim 24, wherein the processor is configured to calculate the modified QP values for the quantized transform coefficients based on the associated quantization matrix entries used as offsets to the integer multiple of the base QP value.

28. The video coding device of claim 20, wherein the processor is configured to clip the quantized transform coefficients to 16-bit signed prior to calculating the dequantized transform coefficients.

29. The video coding device of claim 20, wherein, when level values of transform coefficients are restricted to 16 bits during encoding, the processor is configured to calculate the dequantized transform coefficients without clipping the quantized transform coefficients.

30. A video coding device for encoding video data, the device comprising:
a memory configured to store video data; and
a processor configured to calculate modified quantization parameter (QP) values for a plurality of transform coefficients of a video block based on associated quantization matrix entries used as offsets to a base QP value, wherein the modified QP values provide uniform QP granularity across all of the quantization matrix entries, and calculate quantized transform coefficients from the transform coefficients of the video block based on the modified QP values.

31. The video coding device of claim 30, wherein the processor is configured to calculate a modified QP value for a given transform coefficient by adding an associated quantization matrix entry value to the base QP value.

32. The video coding device of claim 30, wherein the processor is configured to calculate a quantized transform coefficient by dividing a given transform coefficient with a scaling array entry for the modified QP value.

33. The video coding device of claim 30, wherein the processor is configured to calculate a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry associated with the given quantized transform coefficient, and offset indicates an offset of the quantization matrix entry.

34. The video coding device of claim 30, wherein the processor is configured to set a modified QP granularity for the transform coefficients equal to an integer multiple of a basic QP granularity.

35. The video coding device of claim 34, wherein the processor is configured to clip each of the modified QP values to be within a modified range equal to the integer multiple of a range for QP values at the basic QP granularity.

36. The video coding device of claim 34, wherein the processor is configured to calculate the quantized transform coefficients based on the modified QP values and a scaling array that includes a number of entries equal to the integer multiple of the basic QP granularity.

37. The video coding device of claim 34, wherein the processor is configured to calculate the modified QP values for the transform coefficients based on the associated quantization matrix entries used as offsets to the integer multiple of the base QP value.

38. The video coding device of claim 30, wherein the processor is configured to restrict level values of the transform coefficients to 16 bits prior to calculating the quantized transform coefficients.

39. A video coding device for decoding video data, the device comprising:
means for calculating modified quantization parameter (QP) values for a plurality of quantized transform coefficients of a video block based on associated quantization matrix entries used as offsets to a base QP value, wherein the modified QP values provide uniform QP granularity across all of the quantization matrix entries; and
means for calculating dequantized transform coefficients from the quantized transform coefficients of the video block based on the modified QP values.

40. The video coding device of claim 39, wherein the means for calculating modified QP values comprise means for calculating a modified QP value for a given quantized transform coefficient by adding an associated quantization matrix entry value to the base QP value.

41. The video coding device of claim 39, wherein the means for calculating dequantized transform coefficients comprise means for calculating a dequantized transform coefficient by multiplying a given quantized transform coefficient with a scaling array entry for the modified QP value.

42. The video coding device of claim 39, wherein the means for calculating modified QP values comprise means for calculating a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry value associated with the given quantized transform coefficient, and offset indicates an offset of the quantization matrix entry value.

43. The video coding device of claim 39, further comprising means for setting a modified QP granularity for the quantized transform coefficients equal to an integer multiple of a basic QP granularity.

44. A computer-readable medium comprising instructions for decoding video data, the instructions, when executed, cause one or more processors to:
calculate modified quantization parameter (QP) values for a plurality of quantized transform coefficients of a video block based on associated quantization matrix entries used as offsets to a base QP value, wherein the modified QP values provide uniform QP granularity across all of the quantization matrix entries; and
calculate dequantized transform coefficients from the quantized transform coefficients of the video block based on the modified QP values.

45. The computer-readable medium of claim 44, wherein the instructions cause the processors to calculate a modified QP value for a given quantized transform coefficient by adding an associated quantization matrix entry value to the base QP value.

46. The computer-readable medium of claim 44, wherein the instructions cause the processors to calculate a dequantized transform coefficient by multiplying a given quantized transform coefficient with a scaling array entry for the modified QP value.

47. The computer-readable medium of claim 44, wherein the instructions cause the processors to calculate a modified QP value for a given quantized transform coefficient at position [i][j] according to QP_{mod} [i][j]=g*QP+(M[i][j]−offset), where g indicates an integer multiple of a basic QP granularity, QP indicates the base QP value, M[i][j] indicates a quantization matrix entry value associated with the given quantized transform coefficient, and offset indicates an offset of the quantization matrix entry value.

48. The computer-readable medium of claim 44, further comprising instructions that cause the processor to set a modified QP granularity for the quantized transform coefficients equal to an integer multiple of a basic QP granularity.
